(19) United States
(12) Patent Application Publication
(10) Pub. No.: US 2024/0054292 A1
(43) Pub. Date: Feb. 15, 2024

(54) CONVERSATION ORCHESTRATION IN INTERACTIVE AGENTS

(71) Applicant: SOUL MACHINES LIMITED, Auckland (NZ)

(72) Inventors: Jeremy Chen, Auckland (NZ); Hannah Clark-Younger, Auckland (NZ); Andrew Haslam, Auckland (NZ); Nader Ayyad, Auckland (NZ); John Pletka, Auckland (NZ); Maruo Masserini, Auckland (NZ); Liam Pool, Auckland (NZ)

(21) Appl. No.: 18/266,865

(22) PCT Filed: Jan. 5, 2022
(86) PCT No.: PCT/IB2022/050071

§ 371 Date: Jun. 13, 2023

(30) Foreign Application Priority Data
Jan. 5, 2021 (NZ) 771659

(51) Int. Cl. G06F 40/35

(52) U.S. Cl. CPC G06F 40/35

(57) ABSTRACT

Embodiments described herein relate to methods and systems for animating (bringing to life) an Agent, which may be a virtual object, digital entity, and/or robot. A Router enables seamless interactions between a user and the Agent via multiple Skill Modules. Skill Modules may include conversation corpora and/or other applications. Embodiments described herein may improve Conversation Orchestration in Interactive Agents in the context of multi-modal human-computer interactions.

### TECHNICAL FIELD

Embodiments described herein relate to improving interactions between a user and an Agent: more particularly, but not exclusively, improving Conversation Orchestration in Interactive Agents in the context of multi-modal human-computer interactions.

### BACKGROUND ART

U.S. Ser. No. 10/742,572B2 discloses a method of orchestrating a plurality of chatbots by parsing chat messages to discover an intent and entities contained in the chat messages. A ranking algorithm ranks the master chatbot and modular chatbots, and the chat messages are forwarded to the highest ranked chatbot.

U.S. Pat. No. 7,421,393B1 discloses a system for developing a dialog manager using modular spoken dialog components. The dialog manager is generated according to a method comprising selecting a top-level flow controller based on application type and selecting available reusable sub dialogs for each application part.

### OBJECTS OF THE INVENTION

It is an object of the present invention to improve interaction orchestration in interactive agents or to at least provide the public or industry with a useful choice.

### BRIEF DESCRIPTION OF DRAWINGS

FIG. 1 shows an interaction orchestration system;

FIG. 2 shows a flow diagram of Input Request processing;

FIG. 3 shows a flow diagram of Output Response processing;

FIG. 4 shows a conversation orchestration system including an Augmentation Corpus;

FIG. 5 shows a conversation orchestration system configured to support innate knowledge;

FIG. 6 shows a Router having established multiple connections to the same corpus;

FIG. 7 shows a multi-topic conversational system;

FIG. 8 shows a method of generating Interaction Rules;

FIG. 9 shows a conversation orchestration system configured to process Output Responses;

FIG. 10 shows a flow diagram of routing between various Skill Module types

FIG. 11 shows a Rule Template for a Response Rule.

### DETAILED DESCRIPTION

Embodiments described herein relate to methods and systems for animating (bringing to life) a computer-implemented Agent, which may be a virtual object, digital entity, and/or robot, presented in any suitable manner. The Agent receives inputs or stimuli originating from real-world stimuli comprising, for example, an input from one or more of a camera, electromagnetic transducer, audio transducer, keyboard or other known systems. The input may derive from a human user interacting with the Agent, for example via an end-user device such as a computer. The Agent may produce audial, graphical, visual and/or any other suitable output. The Agent may be presented with an anthropomorphic voice and/or appearance and converse with a user in natural language. In embodied agents, the Agent may additionally interact with the user via non-verbal communication such as gestures, facial expressions and body language.

The Agent may be hosted on an Agent Platform, programmed by an Agent Platform provider. Various Skill Modules, which may be hosted externally from the Agent Platform may control aspects of the interaction. A Router 4 orchestrates seamless interactions between a User and the Agent via one or more Skill Modules, improving the interaction between the Agent and the User. A skill is a conversation component, or more broadly interaction component that can be added to an interactive Agent to enhance its capabilities.

Skills can be implemented in any suitable manner, such as in a cloud platform (e.g. on NLP platforms such as Watson, Dialogflow), or be custom built and connected to via an orchestration server or webhook, or connected to via a skills API, or integrated into the Agent Platform. Skills may be standalone, or be designed to work alongside or supplement other skills an interaction. An external Application Programming Interface (API) is configured to enable 3^{rd} parties to build Skill Modules which may be additional distributed conversational systems, conversational content and/or other interaction abilities. Skill Modules may include conversation corpora and/or other applications. Alternatively and/or additionally, an internal API is configured to enable 3^{rd} parties to build new conversational systems, content, and/or other interaction enhancements that is compatible with the interaction orchestration system and integrated directly with the Agent Platform, on which the Agent is hosted.

In one embodiment, through the use of Interaction Rules, the Router 4 delivers a low-level system of directives to specify when a specific Conversation Instance Skill Module should be active, when to change to another Conversation Instance Skill Module, as well as specifying additional conversational behaviour that aids in transitioning between Conversation Instances and thus enabling coherent conversational interaction. In digital assistant and chatbot applications, the Router may assist in directing user input to an appropriate conversational chatbot if multiple chatbots are available with varying skillsets, thus increasing the chances that the user input is accurately and efficiently handled. A set of Conversation Rules may be generated from a list of Skill Metadata of Conversation Instance Skill Modules automatically.

Skill Modules are not restricted to interacting with the user in a conversational, turn-based manner. Examples of this functionality include the transformation of user input or agent responses, and reconfiguration of the Agent platform. Examples include Skill Modules that facilitate translations, natural language understanding, emotional intelligence, automatic gesture generation for embodied Agents.

Conversational Orchestration

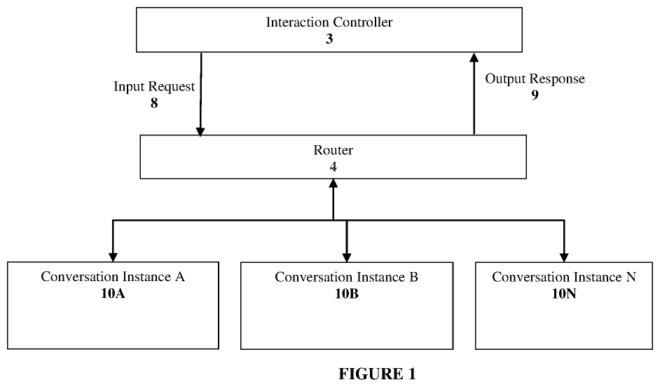

FIG. 1 shows an interaction orchestration system, configured for routing between Skill Modules, specifically, between Conversation Instances. A Router 4 maintains a set of routed Conversation Instances 10, each identified by an Identifier (ID). The ID is used by rules to identify a target Conversation Instance 10. Each Conversation Instance 10 can be provided by any suitable Conversation Source. Conversation Sources may be generally authorable dialogue systems and/or chatbots providing specific conversational content, and may be authored by independent parties. The Conversation Source may originate from a 3^{rd} party service providing conversation systems and/or conversational content. Examples of such services include Amazon Lex, Microsoft Azure Bot Framework, Facebook Blenderbot, IBM Watson and Google DialogFlow.

The Router 4 keeps a record of a Default Instance 12, the Current Instance 11 and a Stack maintaining a record of the last n (e.g. five) Current Instances 11. At initialisation, the Current Instance 11 is set to the Default Instance 12. The Router may transition between two or more Conversation Instances. Each Conversation Instance 10 is associated with an Instance Rule Set 19. The Instance Rule Set 19 may contain a list of Request Rules, Response Rules, and/or Interruption Rules. Likewise, the Router 4 may have a Global Rule Set 15 including Request Rules, Response Rules, and/or Interruption Rules.

Multiple Conversation Instances may point to the same Conversation Source. Pointing multiple distinct Conversation Instances to the same Conversation Source enables digressions or fallback within or between subsections in a Conversation Source as each Conversation Instance tracks the User's state/session independently—meaning re-entry to a given subsection would have the original conversation state intact as when it was digressed from or when fallback was triggered.

Components of Interaction Rules

Interaction Rules include a Target ID, Conditions and/or Actions. Interaction Rules are configurable in any suitable manner, including, but not limited to in a JSON structure or other any structured document format such as Markdown, YAML, XML. Interaction Rules may be read from a text file, or any suitable file, generated programmatically, by a machine learning model, or authored directly in the Router 4 code.

Conditions

Interaction Rules may include Conditions to match against any suitable data. For example, intent recognition or regular expression matching may be used to trigger Interaction Rules. Any suitable Boolean or comparison operators may be used, including but not limited to: existence (“contains”), (in)equality, greater-than, greater-than-or-to, less-than, less-than-or-equal-to. More complex Interaction Rules may include nested conditional structures, combined using AND, OR and NOT blocks. An intent match from a natural language understanding (NLU) service may be used (e.g. a SNIPS intent match). In such cases the Condition may define a required intent match confidence. For an entity match (e.g. a SNIPS entity match) common entity values may be name, or slot values.

Actions

Interaction Rule Actions may be represented by output format strings or command format strings. Format strings can be used to construct arbitrary combinations of both free form text and specific values available from the Request Rule and Response Rule processing via format string arguments. For example: “output”: “Ok, I'll repeat that you said %input” is an output format string that emits a text string for the Agent to utter that consists of a free text prefix followed by the value of %input, which is the “the speech to text” text in an Input Request. Each Action format string has a set of valid format string arguments that can be used.

Target ID

Interaction Rules may include a Target ID, which specifies an identifier of an Entry Instance (the instance that will become the Current Instance 11). For example, in one embodiment: an empty Target ID indicates to continue using the current instance, a Target ID of ‘_last_’ switches the current instance to the prior current instance, a target ID of ‘_pop_’ removes the current instance from the top of the instance stack and change it to the instance now at the top of the stack and a target id of ‘_default_’ switches the current instance to the nominated default instance.

Transition Actions

If a Interaction Rule match results in a change to the Current Instance 11, the Router 4 assumes nothing about what actions or behaviour should result and by default will emit no Agent utterances, perform actions or make requests to Conversation Instances. The Interaction Rule specifies the conversational behaviour required when a Conversation Instance change is detected.

Transition actions describe the behaviour of the Router 4 when a matched rule targets a conversation instance that differs from the current instance. Examples of transition actions include:
exit_command, which sends a text command to the Exit Instance (The instance that will soon no longer be the Current Instance 11). The exit command specifies a format string that can be used to construct text to send to the Exit Instance.
entry_command, which sends a text command to the Entry Instance. The entry_command specifies a format string that can be used to construct an input to send to the soon-to-be current instance. E.g. “entry_command”: “the input text was %input”
output, which constructs and emits a text string for the Agent to utter. The ‘output’ specifies a format string that can be used to change or replace an utterance when transitioning from one instance to another.
output_fallback, which constructs and emits a text string for the Agent to utter if the output string could not be constructed because one or more of the format argument values were missing or blank. This action can be useful when constructing output segue or repeat utterances that embed a prior response in the string. If there has not yet been a prior response, this action can be used to construct an alternate utterance.
process_entry_command_response, which, when set to true, forces the Router to process the response to the entry command and attempt to match rules with it. Thus, the Router processes the response resulting from entering an instance or chain responses together.
revert_entry_instance which, rolls back the state of entry instance conversation to the state received by the Router 4 as part of the second to last response from that instance. This sets a flag that forces the next request to the entry instance to pass in the last conversation state—with the resulting effect that the conversation had been rolled back a turn before interpreting the request.
revert_exit_instance, which rolls back the state of exit instance conversation to the state received by the Router 4 as part of the second to last response from that instance. This sets a flag that forces the next request to the exit instance to pass in the last conversation state—with the resulting effect that the conversation had been rolled back a turn before interpreting the request.
reset_entry_instance sends a reset to the entry instance conversation. For supported conversation platforms, this forces the conversation to its initial state.
reset_exit_instance, sends a reset to the exit instance conversation. For supported conversation platforms, this forces the conversation to its initial state.
reset_all sends a reset to all instance conversations, which forces each conversation to its initial state.

Non-Transition Actions

Non-transition actions describe the behaviour of the Router 4 when a matched rule identifies the current instance as the target i.e. no change in the current instance. If a rule match results in no change to the Current Instance 11, the default behaviour of the Router 4 when it processes the Interaction Rule is to emit the response text for a Response Rule and send the request input text as the command for a Request Rule. If no Transition Action is detected in a matched Interaction Rule and there are no actions specified, there will be no change in behaviour compared to when no Interaction Rule is defined.

Arguments

Any suitable arguments (interaction variables) can be used in conditions, and/or actions. Examples include, but are not limited to:
%exit_instance_last_response: The last response received from the exit instance
%entry_instance_last_response: The last response received from the entry instance
%last_utterance: The last response from any instance
%input: The matched request's input text
%exit_command_response: The response received from the command sent to the exit instance ie. the response to the exit_command described above, if it was specified.
%entry_command_response: The response received from the command sent to the entry instance i.e. the response to the entry_command described above, if it was specified.

Categories of Interaction Rules

Request Rules

Request Rules are processed by the Router just prior to passing the Input Request to the Current Instance. Request Rules may include a Target ID, Conditions, and Actions, which may be Transition Actions or Non-Transition Actions.

An Input Request may be any suitable input received from and end-user, and may be a verbal question or statement made by a user, a non-verbal communication by the user (e.g. received via and end-user camera), a typed message from a user, a GUI interaction by the user, or any other interaction by the user with the Agent.

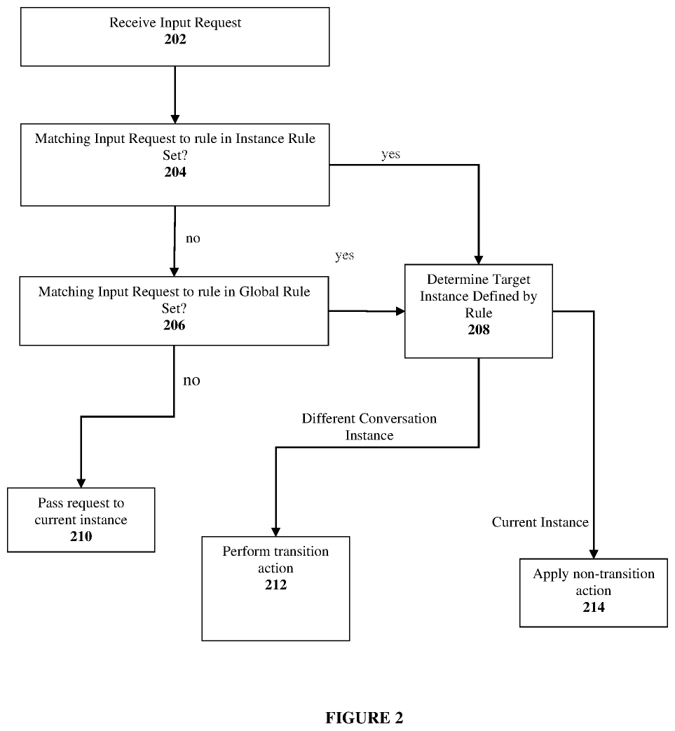

FIG. 2 shows a flow diagram of Input Request processing. The Router 4 intercepts Input Requests received from a Interaction Controller 3 and inspects them before passing them on to the Current Instance 11. At 202, the Router 4 receives an Input Request. On receipt of an Input Request 8 from the Interaction Controller 3, the Router 4 polls the Current Instance 11 for a match against a Request Rule contained in its Rule-base. In other words, the Router searches for an applicable Interaction Rule. At 204, the Router 4 first attempts to match the request to a rule configured in the Instance Rule Set for the Current Instance 11. At 206, if no rule is matched on the Current Instance 11, the Router 4 attempts to match the request to a rule configured for the Global Rule Set (polls the global rule set for a match against its Request Rules). Matching Input Requests to rules is performed using the Condition specified in each rule. If a Interaction Rule is matched, the Router 4 determines the Conversation Instance identified by the Target ID of the Interaction Rule. If a matching Request Rule is found, the Router 4 determines if the match of the Interaction Rule (the Request Rule) will result in a change of Current Instance 11.

Depending on whether a change to the Current Instance 11 is detected, the Router 4 performs optional transition or non-transition operations as specified by the Request Rule. These operations include emitting interstitial/segue utterances and phrases, issuing commands to the Exit Instance and/or Entry Instance as well as emitting the responses to those commands. If a change of Current Instance 11 is detected, the Router 4 changes the Current Instance 11 once all actions have been performed. If there is no rule match against the Input Request, the Router 4 passes the request to the Current Instance 11.

Response Rules

Response Rules are processed immediately following receipt of an Output Response by the Router from a Conversation Instance. The Current Instance or any Conversation Instance may trigger a Response Rule.

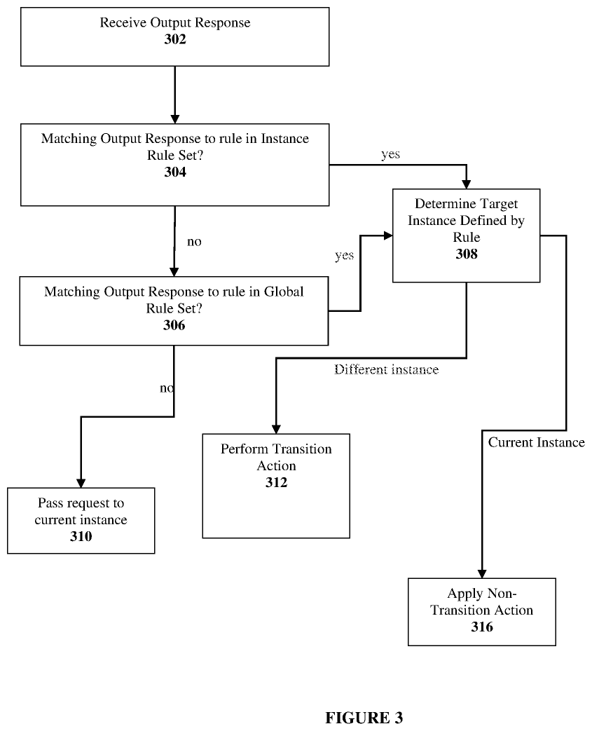

FIG. 3 shows a flow diagram of Output Response processing. The Router 4 intercepts all Output Response traffic from Conversation Instances and attempts to match Output Response traffic with Response Rules. At 302, an Output Response is received. The Output Response may be received from any Conversation Instance, not just the Current Instance 11. This enables Conversation Sources to provide unsolicited responses or to provide conversational input based on other stimulus or signals. The Router 4 first attempts to first match a Response Rule from the rule set for the instance it received that response from, at 304 (regardless of whether that is the Current Instance 11 or not). The Router 4 polls the instance that it just received the response from for a match against a Response Rule contained in its Instance Rule Set. If no matching rule is found from the Instance Rule Set, then the Router 4 attempts to match from the Global Rule Set (polls the Global Rule Set for a match against its Response Rules), at 306. If a Response Rule is matched, the Router 4 determines the Target ID of the target instance identified by the Interaction Rule, at 308. If a matching Response Rule is found, the Router 4 checks to see if the match of the rule will result in a change of Current Instance 11. Depending on whether a change to the Current Instance 11 is detected, the Router 4 performs optional transition 312 or non-transition 316 operations as specified by the Interaction Rule. These operations can include emitting interstitial/segue utterances and phrases, issuing commands to the old and/or new instances as well as emitting the responses to those commands. If no rule match is made against the response, the Router 4 passes the response to the Current Instance at 310. Otherwise, the Router 4 changes the Current Instance 11 to be the Entry Instance identified by the Interaction Rule.

The conversation traffic to and from the collected Conversation Instances 10 is monitored and various aspects of the traffic can determines when to alter the flow of the conversation traffic to/from the participating Conversation Instances 10.

Interruption Rules

Interruption Rules interrupt an Agent mid-utterance. Examples of Interruption Rules that trigger when one or more of the following Conditions are met include:
When the user has spoken loudly enough (voice is detected above a threshold), and
the user is paying attention to the screen (this may be determined using a face detection and/or eye-gaze detection system); and
The Agent is currently speaking

To prevent repeated interruption responses, the Router 4 may be configured to not process any other interruptions until a (configurable) predefine period of time (“interruption suppression period”) has elapsed, and a new request is received by the Router 4, e.g. 3000 ms.

Rule Sets—Instance Specific Vs Global

Instance Rule Sets allow for the creation of highly targeted and specific rules that are matched based on traffic to and from the specific Conversation Instance they have been configured in. Instance Rule Sets may each contain a list of request, response and Interruption Rules.

A Global Rule Set is defined, which desirably makes it easier to add default behaviour for all Conversation Instances in a single location; and specify a rule to control behaviour before a Conversation Instance is defined e.g. when implementing generic routing behaviour designed to work with black-box third party corpora. The Global Rule Set is defined at the global level and contains a list of request, response and Interruption Rules. The Global Rule Set is searched if no rule is matched from the Instance Rule Set.

### Example Implementations

Multiple Corpora

FIG. 5 shows a system configured for innate knowledge. The Router intercepts any Input Requests from Users matching Interaction Rules associated with innate knowledge. The Router diverts Input Requests to an Augmentation Corpus (dashed lines), or handles Input Requests directly using responses programmed in its Interaction Rules (solid lines).

Content is authored directly in the Interaction Rules via Request Rules with “output” Non-Transition Actions. This enables single-turn responses to queries which match with an NLU intent. This may endow an Agent with innate knowledge such that the Agent is able to answer pre-determined questions or otherwise respond in a predetermined manner to input. Examples include answers to commonly asked questions, such as ‘What is your name?’ and ‘Who made you?’.

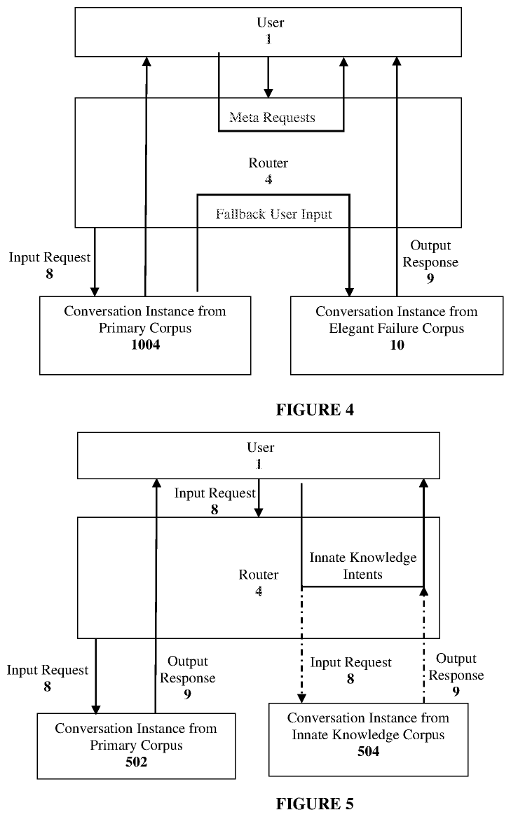

FIG. 4 shows a conversation orchestration system including an Augmentation Corpus. In one embodiment, the Augmentation Corpus is an “elegant failure” corpus designed to respond elegantly when the Conversation System is not able to respond to a user's input. All user utterances are sent to the primary corpus initially. Meta-requests e.g. (‘can you repeat’) are handled by the Router 4 directly. If the primary corpus is unable to handle a user request, it is routed to the “elegant failure” corpus.

One-Shot Augmentation with Multiple Corpora

FIG. 7 shows a multi-topic conversational system. A primary corpus and n topic corpuses are provided. The Router intercepts user input related to Topic 1-x and sends it to the appropriate corpus. The Router 4 requires knowledge of what is handled by the topic-specific corpora. All other input is sent to the primary corpus.

The Router 4 augments a Target Corpus with an Augmentation Corpus. A Global Rule Set is authored or provided whereby Interaction Rules use an intent to match against Input Requests to trigger against one of the topics that the Augmentation Corpus is capable of responding to. When a Interaction Rule triggers, the Router 4 sets the Current Instance to be the Augmentation Corpus instance and redirects the Input Request to the Augmentation Corpus instead of the Target Corpus. The Target Corpus never sees the Input Request that gets redirected because the Router 4 intercepts and redirects the Input Request first.

Another Interaction Rule in the Global Rule Set of the Augmentation Corpus instance matches against Output Responses emanating from the Augmentation Corpus and resets the Current Instance to the Target Corpus, before emitting the Output Response from the Augmentation Corpus.

The Interaction Rule may incorporate a segue phrase, such as %exit_instance_response. And now, back to where we were’.

The solution is simple and robust because the Router 4 is able to predict where the Current Instance is because the augmentation instance always redirects to the target corpus when it sees the response to the request it initially redirected.

Interaction Rules can modify both the Input Request 8. For example, Interaction Rules may rephrase the request so the augmentation corpus has a better chance of correctly identifying the topic—allows for extension of the intents without having to modify the corpus itself). With request modification, a user utterance can be combined with additional text or replaced completely before submitting it to the conversation instance.

Interaction Rules can modify the Output Response 9 from the augmentation corpus. The Router 4 can combine a Output Response 9 from the conversation instance with additional text (e.g. for a segue), or replace it completely.

Fallback Shifting

In Fallback shifting, a single Target Corpus Response Rule detects when the Target Corpus Conversation fallback node has been hit (as opposed to matching against specific topic related requests to the Target Corpus). The Interaction Rule masks the response from the target's fallback node and passes the identical request to the augmentation corpus. The Router “traps” every response and resets the current instance to the Target Corpus after emitting the Output Response from the Augmentation Corpus. The Augmentation Corpus may also fail to recognise the Input Request, and trigger its own fallback node. The Augmentation Corpus' fallback node may be more specific in its content due the fact that it would only be triggered after passing 2 levels of matching. The augmentation fallback response does not trigger the original fallback match rule because that rule only matches against responses from the Target Corpus.

Fallback shifting is more robust than innate knowledge because the Router's intent matching is not required to detect all possible ways of referring to its topics, and instead relies on the fact that the Target Corpus did not know anything about what was being asked of it. In addition there is no possible overlap in the possible domain of intents that can be competing to be matched because it is matching on fallbacks, not on content (an intent). Interaction Rules may undertake any suitable Input Request or Output Response modifications.

Position Preservation

The Router may implement current position preservation. Using ‘revert’ actions in a Interaction Rule a target conversation can be reset to the last known good position prior to the fallback triggered digression returning to the Target Corpus.

Mode Shifting

In Mode shifting, two or more corpora may be provided, with an Augmentation Corpus providing some supplementary content, such as Agent special interests. The author of the Interaction Rules knows about the content of each.

A Target Corpus Instance Rule Set and/or a Global Rule Set that know about the topics in each corpus enables switching to a new corpus on a more long term basis. When a change in topic is detected, the Router switches the current instance to the appropriate corpus and passes the request on. This is a glassbox approach and suitable for multi-turn conversations. Alternatively, responses may be marked up with metadata to indicate when a multi turn interaction is finished.

Mode shifting may detect when specific outlets from one conversation to another are authored—so a first corpus has some part of the interaction tailored to detect when the user may be interested in switching to a history of what's covered in the Target Corpus e.g. an ability to allow delivery of more specific information related to the Target Corpus without having to disrupt the Target Corpus itself too much. Metadata matching could be used for this—wherein the Target Corpus emits a context value indicating that some rule should trap it and switch to the other corpus.

Configure Multiple Router Instances, One Per Topic in a Single Target Corpus

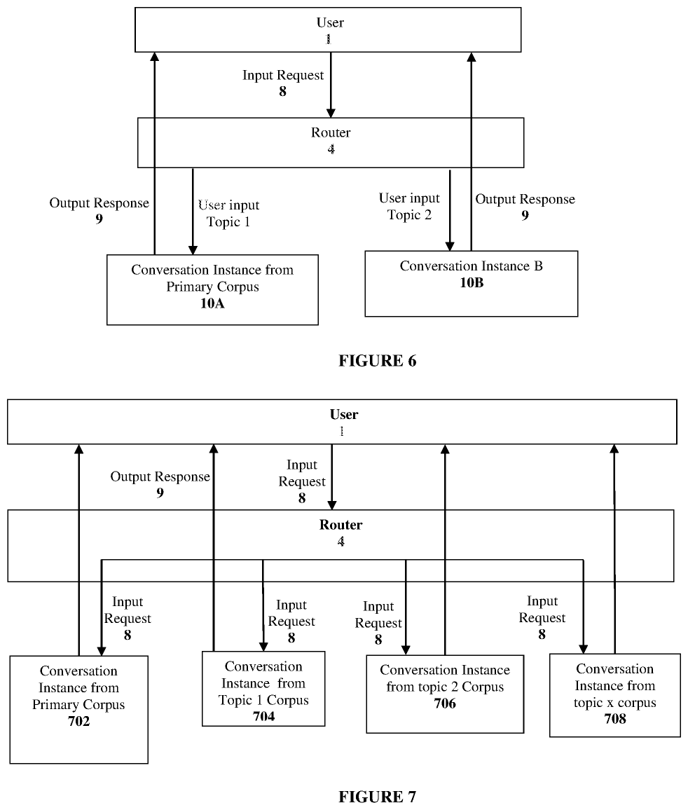

FIG. 6 shows a Router 4 having established multiple connections to the same corpus. If these Router 4 has knowledge of the internal structure of the corpus, it is able to jump between different topics in the corpus without losing track of progress on a particular conversational thread.

Each instance points at the same single corpus with rules authored similar to those in Mode shifting.

Router 4 makes multiple separate connections to the same corpus and the connection is what determines the conversation context, navigating around in one topic in the corpus does not disrupt the location in another topic of the same corpus. This provides topic independent navigation without losing position in the other topics.

Skill Module Orchestration

Skill Modules

A “Skill Module” is an application participating in a Agent-User interaction and are configured to receive input from and/or generate output to the interaction. Multiple Skill Modules may be active at any given time, and multiple instances of Skill Modules may also be active at any given time. Skill Modules may include, among other things, any application, such a cloud application, web-application in a web browser, application on a device such as a mobile phone, tablet computer, laptop computer, or desktop computer. Skill Modules can provide functionalities such as, but not limited to: interacting with the user through the Agent or GUIs, performing tasks (e.g. taking notes, scheduling calendar events or sending emails); providing services (e.g., answering user questions, retrieving map directions); gathering information; operating a user's computing device (e.g., setting preferences, volume, adjusting screen brightness, toggling settings). Skills can be in the domain of entertainment, productivity, finance, relaxation, news, health & fitness, smart home, music, education, travel, food & drink, travel, or any other domain.

Adding Skill Modules

A Skill Module can be associated with or added to an Agent. Skill Modules can be developed by an enterprise and then added to an Agent e.g., through a user interface provided by Agent platform builder for registering the Skill Module with the Agent. In other instances, a Skill Module can be developed and created using the Agent platform builder, and then added to an Agent created using the Agent platform builder. In yet other instances, the Agent platform builder provides an online digital store (referred to as a “skills store”) that offers multiple Skill Modules directed to a wide range of tasks.

Skill Module Repository

A Skill Module repository database stores the Skill Metadata for each skill, such that the Skill Metadata can be store into and queried from the Skill Module repository database. A Skill Module repository service may provide an API to retrieve the available skills, as well as adding/removing skills. For example, to enable a GUI to present a list of available skills, the GUI would make a query to the skill repository service to retrieve a list with the information of available skills.

“Skill Usage Configuration” Repository

Some skills instances require additional configuration, e.g. additional information to personalize the skill to a conversation instance. For example, a Watson or DialogFlow skill would require endpoint and authentication information from the customer. A FAQ skill may require a store of questions and answers. The Skill Metadata contains meta information about what configurations the Skill Module requires, and a programmer of an Agent interaction experience may supply the information required by the skill. This “configuration data” may be stored in a suitable repository.

Rule Generator

Given a list of Skill Modules associated with Skill Metadata for each Skill Module, a Rule Generator automatically generates the Interaction Rule sets required to route between and/or activate the various Skill Modules. This enables Skill Modules to be easily selected and/or combined by a user without knowledge of the underlying mechanics of the Router, enabling construction of a complex interaction spanning multiple topics and use-cases in a short amount of time, potentially without the need for manual authoring of responses to user input.

The Rule Generator may generate a set of rules every time a conversational instance is launched. A User and/or developer may select from Skill Modules that are active in a particular conversational instance. The Skill Metadata of each Skill Module contains information to allow for the generation of Interaction Rules, including global and instance-specific request and response rules. The Skill Metadata may include any suitable information for generating Interaction Rules, including, but not limited to:
the conditions under which the Skill Module should handle a user request (such as in response to specific user queries/intents)
the conditions under which the Skill Module should stop handling user requests (such as when a particular metadata value or Skill Module output is emitted)
a Module Type which describes its purpose when generating a response
endpoints where Skill Modules are hosted and can be queried
Skill Module specific configuration, such as credentials which will allow the router to connect to and utilize a particular Skill Module

Global and instance-specific rule sets are generated for each Skill Module from a series of predefined Rule Templates which are customized based on the information in each Skill Module's Skill Metadata. Descriptions and types of all other Skill Modules selected for a particular interaction are also used to customize the rule sets for a particular Skill Module in order to enable user requests to be routed from one Skill Module to another appropriately.

Rule Templates may be specified using structured document formats such as JSON or YAML or authored directly in code, and may include fields to be populated by variable values contained in the Skill Metadata of each Skill Module. FIG. 11 shows a Rule Template for a Response Rule implemented in JSON.

Each Module Type is associated with a set of Rule Templates corresponding to applicable Interaction Rules for the Skill Module. Rule Templates may include variables that are populated using corresponding values defined in the Skill Module's corresponding Skill Metadata.

In some embodiments, additional rules (external to the Rule Templates) may be used to customize Rule Templates to create Interaction Rules. For example, the INTENT_MATCHER Module Type Interaction Rules may be customized based on which other Skill Modules will be active in an interaction (as the intent matcher skill routes to other skills based on what is matched).

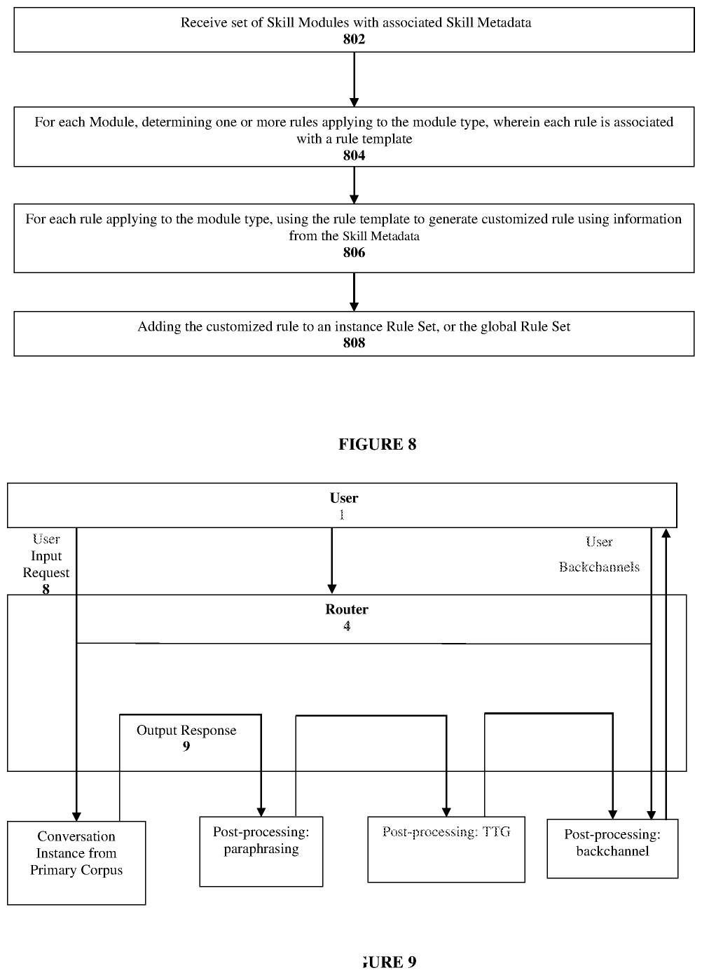

FIG. 8 shows a method of generating Interaction Rules. At step 802, a Rule Generator receives a set of Skill Modules with associated Skill Metadata. At step 804, for each Skill Module, the Rule Generator determines one or more rules applying to the module type, wherein each rule is associated with a rule template. At step 806, for each rule applying to the module type, the Rule Generator uses the rule template to generate customized rule using information from the Skill Metadata associated with the each Skill Module. At step 808, the Rule Generator adds the customized rule to an rule set, which may be an instance Rule Set, or the global Rule Set.

Skill Metadata Authoring

Skill authors and/or Agent platform owners may provide the Skill Metadata, in any suitable format, including JSON or YAML. In some embodiments Skill Metadata information may be automated or partially automated. For example, Skill Metadata information may be extracted from a natural language description of a skill, or taken from similar skills using machine learning.

Rule Operation in Real Time

The router configuration, consisting of the various rule sets and Skill Module instance configurations can be automatically generated at the start of a user's interaction with the Agent, or at the time the interaction is deployed (and any following time when the interaction is modified and re-deployed. The interaction may be reconfigured while it is running as a result of a Skill Module response, user request, or other external trigger to add, delete or modify the Skill Modules included within a particular interaction, at which point the Rule Generator can be re-run to produce an updated configuration for the router to work with the new set of Skill Modules.

Given input from a user or output from a particular Skill Module, the router attempts to obtain a match with a specified rule by processing the rule sets for an instance followed by the global rule set in sequence. However, querying multiple Skill Modules in parallel and comparing returned results using rules provides an alternative approach which may work to reduce latency.

INTENT_MATCHER Skill Module

To reduce the time taken to generate a response and to simplify the automation of rule set generation, an INTENT_MATCHER Skill Module uses natural language understanding and selects the most appropriate skill to route user input to from an arbitrary number of skills.

This Skill Module is separate from the natural language understanding described in [14]. It is not restricted to a particular system/model for natural language understanding and is only required to consume a user request and produce an output which is used by Instance Rule Sets to route user input to a downstream skill.

The rule sets for INTENT_MATCHER Skill Modules are in the form of Response Rules, matching a classified intent to a particular Skill Module, and are generated by examining the Skill Metadata of other Skill Modules to see if they include any intents which Skill Module developers have indicated should be used to route user requests to that particular Skill Module. Training phrases may also be provided alongside intent names to enable the underlying natural language models of the INTENT_MATCHER Skill Modules to be generated based on the selected Skill Modules for a particular interaction.

Providing INTENT_MATCHER via a Skill Module, rather than providing NLP skill routing as inbuilt functionality of the router is advantageous because it enables the underlying natural language understanding algorithms to be easily substituted, and allows for queries to this particular skill module to be made from different parts of the response generation pipeline.

Should there be multiple Skill Modules corresponding to a particular intent, the INTENT_MATCHER Skill Module may perform disambiguation over the course of multiple conversation turns or may pass information about the relevant Skill Modules corresponding to a user request to a subsequent Skill Module to handle this disambiguation process.

### Example—Processing Modules

FIG. 9 shows an interaction orchestration system configured to process Output Responses. The Router 4 routes an Input Request 8 to a Conversation Instance from a Primary Corpus. Output Responses from the primary corpus are routed through a series of custom modules (treated by the Router 4 as if they were separate corpora) which post-process the response. In the system shown in FIG. 9, the custom modules implement post-processing in the form of paraphrasing, and text to gesture (e.g. adding text to gesture mark-up). However, the invention is not limited in this respect—any number of modules may implement any suitable processing.

In one embodiment, a backchannel module is configured to control the delivery of responses back to the user. Modules like these can be designed to respond to some types of user input. All other input can be routed to the primary corpus.

In one embodiment, custom modules are integrated into a wider system defining behaviour of an Agent (such as in an SDK such as to trigger special internal behaviour in the SDK e.g. set runtime variables). For example, the use of a neurobehavioral modelling framework to create and animate an embodied Agent or avatar is disclosed in U.S. Pat. No. 10,181,213B2, also assigned to the assignee of the present invention, and is incorporated by reference herein. Within a neurobehavioral model such as that described in U.S. Ser. No. 10/181,213B2 Interaction Rules may modify internal state of the Embodied Agent and hence modify the agent's behaviour. For example, Interaction Rules may set certain variables in the Embodied Agent which modify the emotional expression of the Agent, which may modify the visual animation and/or vocal expression of the Agent.

In summary, the modules receive an input, process it, execute any desired actions, and pass it back to the Router.

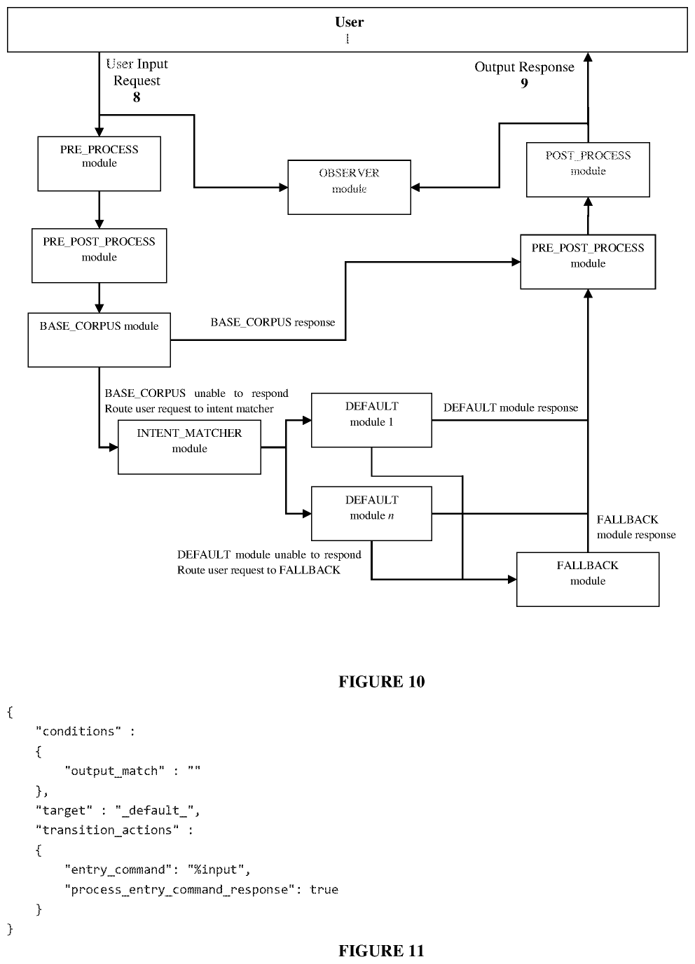

FIG. 10 shows a conversation orchestration system configured with various Skill Module types. Each input/output signal to each Skill Module is routed through the Router (not shown). Skill Module types may include:

BASE_CORPUS Skill Modules, which handle the primary thread of conversation in a particular interaction (and of which there can be only one in a particular interaction). Base corpus skills provide sufficient functionality to drive an interaction by themselves. When a base corpus skill is included in a project, all user input will be sent to it before any other default skill.

DEFAULT Skill Modules, to provide access to expanded conversational capabilities within an interaction in addition to a BASE_CORPUS but are generally more limited in scope; and FALLBACK Skill Modules, which are designed to handle user input when it is detected that no other Skill Modules are able to handle a particular input request. Default skills provide modular/reusable functionality which is meant to work alongside other skills. Default skills receive user input depending on certain conditions specified by a matchType parameter. matchTypes route an initial user invocation to a particular skill and designate it as ‘active’. Skills may implement self-contained natural language understanding capability (intent classification, entity extraction) to handle subsequent conversation turns. The following are examples of matchTypes:
matchType: CUSTOM: User input will be matched with regular expressions.
matchType: INTENT—User input will be matched using an intent classifier
matchType: FALLBACK: A fallback (an indication that a skill cannot handle user input) from another skill will result in original user input being routed to this skill. Default skills with this matchType should implement functionality to handle user input which other skills are not able to handle.

PRE_PROCESS Skill Modules transform user input into a form which is appropriate for downstream Skill Modules, in other words, they process user input before it is sent to any other skill (including base corpus skills).

POST_PROCESS Skill Modules transform the output of upstream Skill Modules prior to the agent speaking the response. Post-process skills process the generated response from base corpus or default skills just before it is spoken by the DP.

PRE_POST_PROCESS Skill Modules combine the functionality of both PRE_PROCESS and POST_PROCESS Skill Modules into a single Skill Module. Example use-cases for these Skill Module types include translation (of both user input and conversational responses), generation and sequencing of gestural markup conditioned by response text and controlling the delivery of responses in a sentence-by-sentence fashion to enable more nuanced turn-taking behaviour in response to verbal and non-verbal signals from the user.

The OBSERVER Skill Module, does not generate any response to be spoken by the agent in response to user input, but instead observes user input and associated responses from Skill Modules along with associated metadata from the Skill Modules or digital agent platform. Applications of these Skill Modules may include multimodal analytics, or to record and subsequently send a transcript of an interaction at its conclusion.

The INTENT_MATCHER Skill Module analyses user input and its response is used by the router to determine a subsequent Skill Module to route the user input to. Intent matcher skills classify and send user input to default skills with matchType: INTENT. At startup, the Intent matcher skill analyses any other default skills in the configuration and generates appropriate routing conditions. When a base corpus skill is present, the intent matcher skill will only be triggered when the base corpus indicates that a fallback has occurred i.e. that is cannot handle the current user input. When no base corpus skill is present, all user input will be sent to the intent matcher skill first.

Should there be multiple instances of a particular Skill Module type, the priority of Skill Modules may be determined in any suitable manner, including randomly, using Skill Module descriptor information, or ordering of the Skill Modules within the original list informs the priority with which a particular Skill Module is able to process a user request.

Metadata/Memory

Skill Modules can share information extracted from User input depending on access permissions defined/granted by each Skill Module. Examples of this information may include the user's name, location, and email address. This metadata may be initialized/retrieved from external storage at the start of a session and persisted to external storage at the end of a session. This metadata is not limited to textual data, but may be of a multimodal nature (images, audio, video etc.).

Skill Modules are configured to access information about the Agent's current state and may also access estimates of the user's state from multimodal models in the agent. This information may correspond to real-time values, or be aggregates over particular periods, such as conversation turns. This information may include the emotional state of the agent and/or user, gestures the user may be performing, or classifications of the observed items in the agent's field of view.

The router passes session metadata gathered (memory) gathered from user interactions with a particular Skill Module/skill to other Skill Modules (if permitted by a scoping mechanism); and persist/retrieve them to/from external storage at the start/end of sessions. This scoping mechanism will enable Skill Module developers to indicate whether metadata can be shared with other Skill Modules, organisations, persisted between sessions, or whether it should be limited to a particular Skill Module only. Each Skill Module may tag information it extracts with a ‘scope’ which will determine whether the information is able to be shared between skills, between sessions, between organisations, or with a single skill only.

Memory shared between Skill Modules and sessions may be stored in any arbitrary data structure. In one embodiment, this takes the form of an array of maps, each containing any number of key value pairs. Structured formats allow for common values to be gathered, shared and utilised by Skill Modules, while unstructured formats may be gathered from data streams and transformed into a structured form to aid queries.

Advantages

A Global Rule Set allows unseen third-party corpora to be augmented, by providing default behaviour that lets the conversation system have access to the functionality defined in a chitchat/identity and navigation corpora without having any knowledge of the content of other participating corpora. Even when Conversation Instances are authored by independent parties, the Router enables smooth transitioning between Conversation Instances. Separate corpora may be authored for different topics to keep the sizes manageable and mix and match them, instead of authoring a single large corpus.

To minimise the effect of any latency in waiting for the Augmentation Corpus, Interaction Rules can provide that an Agent utterance is emitted immediately prior to redirecting the Input Request to cover the ensuing silence while waiting for an Output Response.

Following this approach, a rules author can completely mask some of the conversational behaviour in either of the corpora. For example, a Interaction Rule can match ‘what's your name’ and provide the Agent with a new identity by having the Agent emit ‘Hi, I'm George’ without passing it to either corpus. Thus a ‘blackbox’ implementation is provided as knowledge of the Target Corpus is not required.

Additional conversation behaviour can be introduced with relative ease using Interaction Rules. The Interaction Rules facilitate prototyping and integration of new autonomous conversation functionality and allow for the tactical release of multi corpora functionality/content into production.

The system may provide a more seamless way to provide access to 3^{rd} party apps and services, without a user needing to explicitly ask for the app or service.

1.-15. (canceled)

16. A computer-implemented interaction orchestration system for managing interaction between a user and a computer system presenting an Agent, the computer-implemented interaction orchestration system comprising:
a Controller;
a set of Interaction Rules, each Interaction Rule including a Condition and an Action configured to modify the interaction; and
a Router communicatively coupled to the Controller, configured to:
receive Input Requests from the user and forward the Input Requests to a Skill Module from a set of two or more Skill Modules; and
receive Output Responses from the two or more Skill Modules and forward the Output Responses to the user and/or the Agent,
wherein the Router is configured to trigger corresponding Interaction Rule Actions when Interaction Rule Conditions are matched from Input Requests and,
wherein the Router is configured to trigger corresponding Interaction Rule Actions when Interaction Rule Conditions are matched from Output responses.

17. The computer-implemented interaction orchestration system of claim 16 wherein Skill Modules are Conversation Instances and wherein each Conversation Instance is configured to deliver conversational content from at least one Conversation Source.

18. The computer-implemented interaction orchestration system of claim 17 wherein Actions modify Input Requests and/or Output Responses.

19. The computer-implemented interaction orchestration system of claim 18 wherein Actions concatenate text with values of format string arguments.

20. The computer-implemented interaction orchestration system according to claim 16 wherein Actions route between Conversation Instances.

21. The computer-implemented interaction orchestration system according to claim 16 wherein Actions deliver conversational content independent from Conversation Sources.

22. The computer-implemented interaction orchestration system of according to claim 16 wherein Interaction Rules include a Global Rule Set applicable to all Conversation Sources.

23. The computer-implemented interaction orchestration system of according to claim 16 wherein Interaction Rules include one or more Instance Rule Sets applicable to associated Conversation Sources.

24. The computer-implemented interaction orchestration system of according to claim 16 wherein Interaction Rules are selected from the group consisting of: Request Rules, Response Rules, and/or Interruption Rules.

25. A method for managing an interactive conversation between a user and a computer system presenting an Agent, the method comprising:
receiving, an Input Request from the user or an output response from a set of two or more Conversation Instances, by a Router configured to intercept input requests and output responses;
determining if a Condition of a Interaction Rule from a set of Interaction Rules matches the Input Request or output response;
if the Interaction Rule matches, applying an Action specified by the Interaction Rule, wherein the action modifies the interactive conversation, and
forwarding the Input Request to a Conversation Instance from a set of two or more Conversation Instances or forwarding the Output Response to the user, wherein each Conversation Instance is configured to deliver conversational content from at least one Conversation Source.

26. The method of claim 25 wherein the Action modifies Input Requests and/or Output Responses.

27. The method of claim 26 wherein the Action concatenates text with values of format string arguments.

28. The method of claim 25 wherein the Action routes between Conversation Instances.

29. A computer-implemented method for managing interaction between a user and a computer system presenting an Agent, the method comprising:
receiving, a set of Skill Modules configured to receive input from and/or generate output to the interaction, wherein each Skill Module is associated with a Skill Metadata; for each Skill Module, generating one or more Interaction Rules using the Skill Metadata; and
adding the Interaction Rule to a set of Interaction Rules,
wherein the set of Interaction Rules route between the one or more Skill Modules to govern the interaction between the user and the Agent.

30. The method of claim 29, wherein the step of generating one or more Interaction Rules comprises using the Skill Metadata to determine one or more Rule Templates for determining when the Skill Module is active in the interaction, and generating one or more Interaction Rules by populating the one or more Rule Templates using one or more values from Skill Metadata.
